(19) United States
(12) Patent Application Publication
(10) Pub. No.: US 2017/0094639 A1
(43) Pub. Date: Mar. 30, 2017

(54) PEER TO PEER WIRELESS FUNCTIONALITY BETWEEN DEVICES USING WHITE SPACES

(71) Applicant: MediaTek Singapore Pte. Ltd., Singapore (SG)

(72) Inventors: Raghav Monga, Chandigarh (IN); Amit Kumar Shakya, New Delhi (IN)

(21) Appl. No.: 14/953,033

(22) Filed: Nov. 27, 2015

(30) Foreign Application Priority Data
Sep. 29, 2015 (IN) 1028/KOL/2015

(51) Int. Cl. H04W 72/02; H04W 16/14; H04W 8/00; H04L 29/08

(52) U.S. Cl. CPC H04W 72/02; H04L 67/104; H04W 16/14; H04W 8/005

(57) ABSTRACT

A method for enabling peer to peer (P2P) transmission between a first geo-location database dependent (GDD) station (STA) and a second geo-location database dependent (GDD) station (STA) on a television white space (TVWS) frequency band includes: utilizing the first GDD STA to communicate with a geo-location database (GDB) to retrieve information of available TVWS channels and corresponding power constraints from the GDB; sending a TVWS action frame by the first GDD STA, wherein the TVWS frame includes this information; selecting a plurality of specific channels from the plurality of available TVWS channels to listen for GDD STAs including the second GDD STA; and when the second GDD STA and the first GDD STA are both listening on a same specific channel, beginning P2P communication between the first GDD STA and the second GDD STA.

### BACKGROUND

Television channels broadcast signals on Very High Frequency (VHF) and Ultra High Frequency (UHF) bands. Each individual channel occupies a certain bandwidth within these bands. For example, in the United States, Taiwan, South Korea and Japan, individual channels occupy a bandwidth of 6 MHz; in Italy, Australia and New Zealand, individual channels occupy a bandwidth of 7 MHz and in the United Kingdom, France and China, individual channels occupy a bandwidth of 8 MHz.

In order to prevent interference between adjacent channels, white spaces are created, which are frequency bands where no television signals will be transmitted. On Nov. 4, 2008, the Federal Communications Commission (FCC) of America licensed the use of white spaces for signal transmission by private individuals. The recent switch from analog television to digital has further freed up large amounts of space on the Television White Space (TVWS) spectrum, with the FCC stopping analog transmissions on Jun. 12, 2009. Current regulations allow the use of signals transmitted from portable devices on the frequency band occupied by television channels 21˜51, with the provision that these signals must not interfere with transmissions from television stations and wireless microphones.

Industrial, scientific and medical (ISM) radio bands are already used for wireless (Wi-Fi) transmissions, which need permanent channels. It would be desirable to employ the TVWS band for signal transmissions, as it has better coverage, better wall penetration and is more effective over large distances than Wi-Fi. Solutions developed for wireless technology to use the ISM band are not instantly applicable to the TVWS band, however, for the following reasons.

The three main issues confronting the use of the TVWS band for signal transmission are: spatial variation; spectrum fragmentation; and temporal variation. Spatial variation is due to the fact that the availability of channels on the TVWS spectrum depends on location. It cannot be assumed that a particular channel which is free in a first location is also free in a second location. Temporal variation means that a channel may only be free for a limited amount of time. Just as it cannot be assumed that a same channel is free in a first location and a second location, it cannot be assumed that a same channel is free at a first time and a second time. Therefore, when disconnection occurs, reconfiguration must be performed in order to continue transmissions. Finally, spectrum fragmentation refers to the issue touched upon above, where different countries use different bandwidths for individual TV channels. It cannot be assumed that a particular channel retains the same bandwidth when the location changes. These issues mean that, before signal transmission can begin, it is necessary to have access to information detailing which channels are currently available, and for how long.

As private transmissions must not interfere with TV and wireless microphone transmissions, the FCC regulations dictate that white space devices need to use databases in combination with local signal sensing, so they can accurately determine which channels are free, taking in mind the above considerations of spatial and temporal variation and spectrum fragmentation. A standard geographic database setup is a Registered Location Secure Server (RLSS), which is an entity that accesses and manages a database. The RLSS is therefore a server which acts as an intermediate storage of information about a particular region. The RLSS receives the information from a geo-location database (GDB), which is a database that contains channel related information about the entire region, organizes the information by geographic location and securely holds the location and some operating parameters of one or more basic service sets (BSS). The RLSS serves as a proxy between Access Points (AP) and the GDB. During information transmission, listening devices can access the information in order to perform signal transmission on the TVWS band. As it is not guaranteed that all devices can access the GDB, however, many devices wishing to transmit on the TVWS band must perform passive scanning in order to determine available channels on the TVWS band. Further, when signal transmission is performed between devices which can access the GDB, it is not guaranteed that all channels are commonly available between the two devices.

If current Wi-Fi connection procedures could be used for the white space devices, peer to peer (P2P) communication could be enabled wherein both devices can perform active scanning.

### SUMMARY

It is therefore an objective of the present invention to provide a method and system for enabling peer to peer communication in the TVWS band.

A method for enabling peer to peer (P2P) transmission between a first geo-location database dependent (GDD) station (STA) and a second geo-location database dependent (GDD) station (STA) on a television white space (TVWS) frequency band comprises: utilizing the first GDD STA to communicate with a geo-location database (GDB) to retrieve information of available TVWS channels and corresponding power and channel duration constraints from the GDB; including this information in an TVWS action frame sent by the first GDD STA; selecting a plurality of specific channels from the plurality of available TVWS channels to search for GDD STAs including the second GDDSTA; and when the second GDD STA and the first GDDSTA are both present on a same specific channel, beginning P2P communication between the first GDD STA and the second GDD STA.

A communications system for enabling peer to peer (P2P) transmission on a television white space (TVWS) frequency band according to an exemplary embodiment comprises: a geo-location database (GDB) which stores information of available TVWS channels and corresponding power and channel duration constraints; and a first geo-location database dependent (GDD) station (STA) which communicates with the GDB to retrieve the information of available TVWS channels and corresponding power constraints, includes this information in an TVWS action frame sent by the first GDD STA, and selects a plurality of specific channels from the plurality of available TVWS channels to search for other GDD STAs including at least a second GDD STA; wherein when the second GDD STA and the first GDD STA are both present on a same specific channel, P2P communication is begun between the first GDD STA and the second GDD STA.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a geo-location P2P system according to an exemplary embodiment of the present invention.

FIG. 2 is an illustration of P2P communication between a GDD enabling STA and a GDD dependent device according to an exemplary embodiment of the present invention.

FIG. 3 is an illustration of P2P communication between two GDD enabling STA devices according to an exemplary embodiment of the present invention.

### DETAILED DESCRIPTION

As detailed in the background, Wi-Fi coverage has issues regarding wall penetration and limited coverage. Further, Wi-Fi communication between devices requires short distances. Therefore, it is an objective of the present invention to use peer to peer (P2P) in the TVWS band. Using the TVWS band can increase the coverage area and hence connection can occur between P2P devices at long distances.

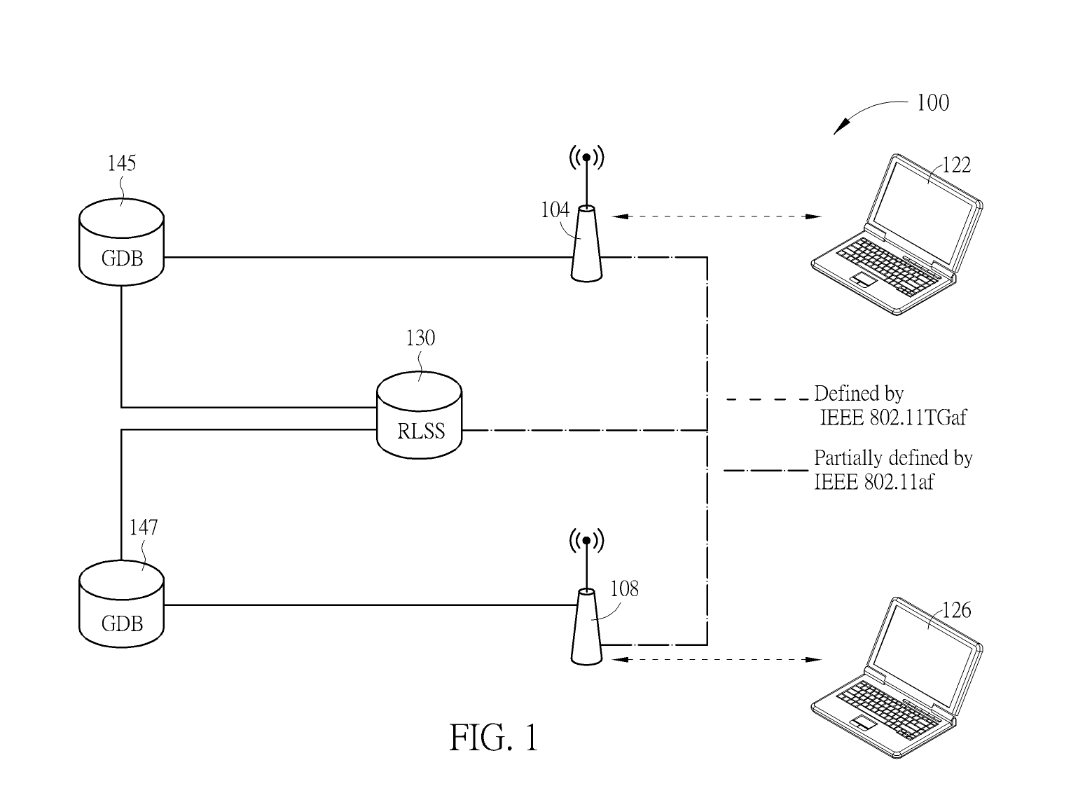

The proposed invention utilizes architecture 100 illustrated in FIG. 1. The architecture includes an RLSS 130 and GDB databases 145, 147, which are defined in the background. The architecture 100 includes geo-location database dependent (GDD) stations (STA) 104, 108, which are used for P2P transmission, and defined as GDD enabling STAs. A GDD enabling STA can be a portable device such as a laptop, or Wi-Fi phone, or a fixed device such as a PC desktop or an access point (AP). The GDD enabling STAs 104, 108 have the capacity to determine their location, i.e. they have geo-positioning ability, and can communicate both with the GDBs 145, 147 and with the RLSS 130. The GDD enabling STAs 104, 108 can obtain information from the databases (GDB) 145, 147 regarding the available spectrum at their particular location and initiate and control operations with GDD dependent STAs 122, 126. In this sense, the GDD enabling STAs 104, 108 operate like a Wi-Fi AP and as an enabling P2P device, but also have the capability of reporting their own geo-location.

As mentioned above, the white spaces architecture 100 also includes a number of GDD dependent STAs 122, 126, wherein the GDD dependent STAs can also be portable devices or a fixed device. The difference between the GDD enabling and GDD dependent STAs is that the GDD dependent STAs only operate as receivers till they receive appropriate channel information from the GDD enabling STA, and cannot communicate with the GDB. Communication between the GDD dependent STAs 122, 126 and the GDD enabling STAs 104, 108 is defined by the IEEE 802.11TGaf specification, and communication between the GDD enabling STAs 104, 108 and the RLSS 130 is partially defined by the IEEE 802.11af specification.

If P2P communication is between two GDD enabling STAs in different locations, although both devices can communicate with the GDB to obtain a current list of available channels and their associated power constraints, the channels available to each STA may be different. Further, if the communication is between a GDD enabling STA and a GDD dependent STA, there is no way for the GDD dependent STA to know which channels are available in the GDD enabling STA's location, as well as the validity of those channels and their respective power constraints, except by listening to beacons on all channels. It is therefore an objective of the present invention to choose the channels for P2P communication in a more efficient manner.

Three potential scenarios are defined in the following:
1) P2P communication between two GDD enabling STAs, wherein both GDD enabling STAs have a same channel list;
2) P2P communication between two GDD enabling STAs, wherein both GDD enabling STAs have a different channel list;
3) P2P communication between a GDD enabling STA and a GDD dependent STA, so only the GDD enabling STA has the channel list.

In scenario 2), it is possible that there are no overlapping channels between the two GDD enabling STAs but this is highly unlikely. The following will therefore discount this possibility and assume that there are some overlapping channels for scenario 2). It should be noted that two dependent STAs cannot establish P2P connection as they do not have any channel information.

No matter whether the P2P is between GDD enabling STAs or between a GDD enabling STA and a GDD dependent STA, the present invention implements a channel selection method by selecting the first three channels received from the GDB with which the GDD enabling STAs communicate. In the first scenario, these channels will be exactly the same for both GDD enabling STAs. In the second scenario, of the first three channels received from the GDB for each GDD enabling STA, it is highly likely that one of these channels is a common social channel. For the third scenario, using the first three channels means that the GDD dependent device can discover the GDD enabling STA easily.

As noted above, the GDD dependent STA can only discover the available channels and power constraints through using a passive scan. The invention therefore introduces a discovery mechanism, wherein a GDD enabling STA can transmit a frame containing this information. This will be referred to as a TVWS action frame. Until communication is initiated between a GDD enabling STA and another device, it is not known whether the other device is an enabling or dependent GDD device (note it is not possible for two GDD dependent devices to communicate with each other). Therefore, all GDD enabling STAs send the TVWS action frames.

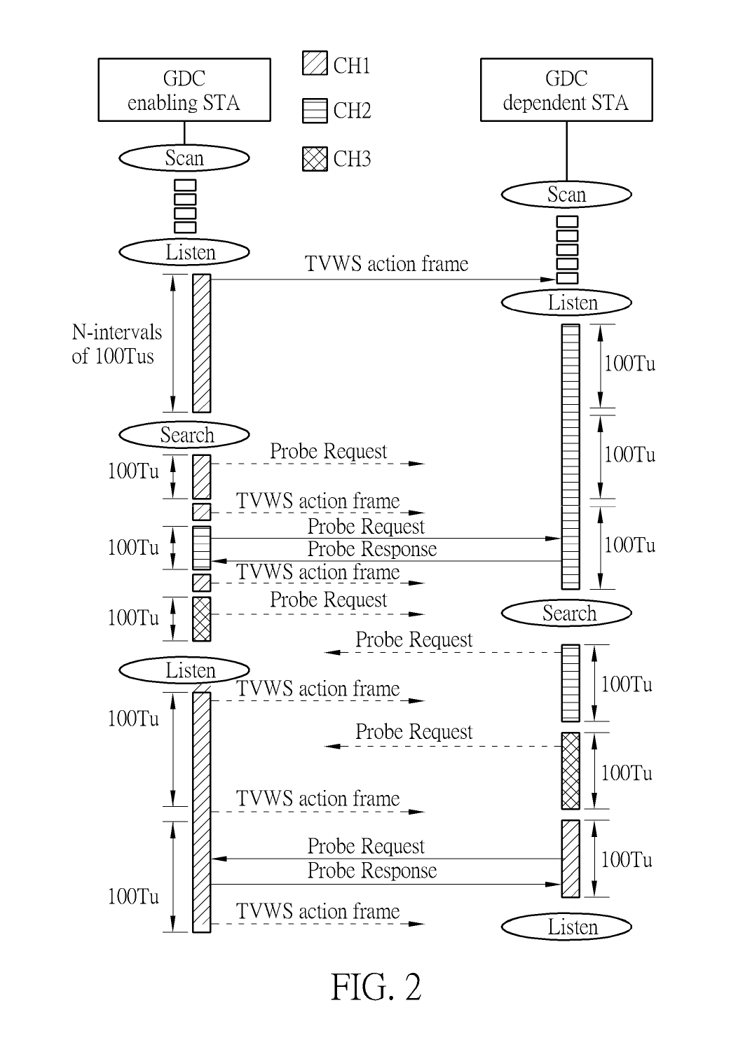

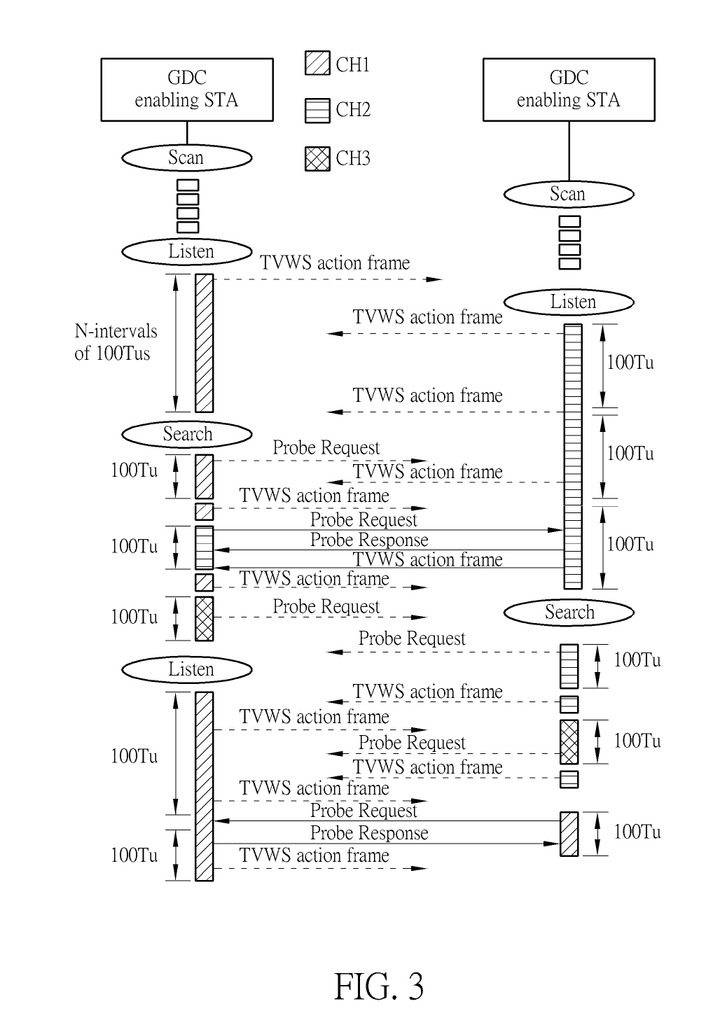

FIG. 2 is an illustration of P2P communication between a GDD enabling STA and a GDD dependent device. FIG. 3 is an illustration of P2P communication between two GDD enabling STA devices. In the prior art, the GDD dependent device can only perform a passive scan to determine available channels and respective power constraints. By utilizing the TVWS action frame, the GDD dependent device can receive power information and availability duration of the first three channels selected by the GDD enabling STA, and therefore begin the discovery procedure.

As illustrated in FIG. 2, both the GDD enabling STA and the GDD dependent STA will scan on all channels. The GDD enabling STA enters a listening mode on a first channel CH1 for N intervals of 100 TUs, wherein N is a random number. At the beginning of the listening period, the GDD enabling STA will send a TVWS action frame, which is received by the GDD dependent STA, and used to begin a discovery procedure on certain channels according to information in the TVWS action frame. In FIG. 2, the GDD dependent STA enters a listening mode on a second channel CH2. The GDD enabling STA then enters a search mode on CH1 by sending a probe request. As the GDD dependent STA is listening on CH2, there is no response. The GDD enabling STA then sends another TVWS action frame on CH1 at the beginning of a next 100 TUs interval, then moves to CH2 and sends another probe request. As this is the same channel as the GDD dependent STA is listening on, the probe request will be received and the GDD dependent STA sends a probe response. The GDD enabling STA then returns to CH1 to send another TVWS action frame in a next beacon interval, then goes to a third channel CH3 and sends a probe request.

As illustrated in FIG. 2, the GDD dependent STA can also enter a scan mode and the GDD enabling STA enter a listening mode where the GDD dependent STA sends the probe requests and the GDD enabling STA receives them and sends probe responses. Note that the GDD enabling STA will still send the TVWS action frames in each beacon interval on CH1. Further, even when P2P communication is enabled, the probe requests can be used to discover other devices, as the channel on which the probe requests are sent is different from the channel on which the GDD STAs listen for other devices.

The TVWS action frame for discovery is transmitted periodically, at every beacon interval. It is noted that the structure of the TVWS frame is different from that of a beacon. It is not advisable to send the power and channel duration information in a beacon, as this will confuse the receiving station, which associates beacons with access points. After each TVWS action frame is sent on a selected channel, a probe request will be sent on a selected channel which may be the same or different from the channel on which the TVWS action frame is sent. The duration of time for sending the TVWS action frame on the selected channel is very small; once the TVWS action frame is sent, the device will immediately move to the other channel to continue its search procedure.

Once an overlapping channel has been selected, the two STAs must negotiate which is to be the group owner (GO). This negotiation may occur on the overlapping channel once the probe request has been received. If the GDD enabling STA which sends the probe request wishes the P2P connection to be made on the non-overlapping channel of the GDD which receives the probe request, it can set its GO intent to zero, effectively making it the P2P client. In scenario 3), as the GDD dependent device cannot be a group owner, a GO intent parameter of the GDD dependent device will always be set to zero. This is because GDD dependent P2P devices will not attempt P2P connection with each other. After this discovery phase detailed above, the P2P connection between STAs is the same as that described in the P2P specification.

FIG. 3 illustrates P2P communication between two GDD enabling devices. As shown in the diagram, both devices send TVWS action frames for discovery by GDD dependent devices. The first GDD enabling STA sends all TVWS action frames on CH1 and the second GDD enabling STA sends all TVWS action frames on CH2. During initialization, the GDD enabling STAs will do a full channel scan in which other GDD enabling STAs may be found. As illustrated in FIG. 2, the GDD dependent STA can receive the discovery frame during scanning on all channels. In FIG. 3, however, the TVWS action frames are only received by either GDD enabling STA when both are listening on a same channel.

In summary, the present invention provides: a mechanism for a geo-location database dependent (GDD) enabling STA to communicate with a geo-location database (GDB) in order to control a geo-location database dependent (GDD) dependent STA for P2P transmission; a means for selecting the first three channels retrieved from the GDB and including this information as well as the power constrains in an TVWS action frame, which is sent periodically by the GDD enabling STA in order to enable discovery by a GDD dependent STA; and providing a Group Owner setting for control of the P2P communication. By means of the above method, discovery of devices using the TVWS band can be achieved quickly, and P2P communication can occur swiftly and efficiently between said devices.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for enabling peer to peer (P2P) communication between a first geo-location database dependent (GDD) station (STA) and a second geo-location database dependent (GDD) station (STA) on a television white space (TVWS) frequency band, the method comprising:
utilizing the first GDD STA to communicate with a geo-location database (GDB) to retrieve information of available TVWS channels and corresponding power constraints from the GDB;
sending a TVWS action frame by the first GDD STA, wherein the TVWS action frame contains the information;
selecting a plurality of specific channels from the plurality of available TVWS channels to listen for GDD STAs including the second GDD STA; and
when the second GDD STA and the first GDD STA are both listening on a same specific channel, beginning P2P communication between the first GDD STA and the second GDD STA.

2. The method of claim 1, wherein the second GDD STA also communicates with a GDB to retrieve information of available TVWS channels and corresponding power constraints from the GDB, selects a plurality of specific channels from the plurality of available TVWS channels to listen for GDD STAs including the first GDD STA, and includes this information in a TVWS action frame sent by the second GDD STA.

3. The method of claim 2, wherein when P2P communication begins between the first GDD STA and the second GDD STA, the first GDD STA and the second GDD STA perform Group Owner (GO) negotiation to determine which GDD STA will initiate transmission.

4. The method of claim 1, wherein the second GDD STA has no geo-location capability to communicate with the GDB, and when the second GDD STA receives the TVWS action frame, the second GDD STA begins searching for GDD STAs on the plurality of specific channels in the TVWS action frame.

5. The method of claim 4, wherein the second GDD STA has a Group Owner (GO) parameter set to zero, so that when P2P communication begins between the first GDD STA and the second GDD STA, the first GDD STA will become the Group Owner (GO) to initiate transmission.

6. The method of claim 1, wherein the plurality of specific channels is a first three channels retrieved from the GDB.

7. The method of claim 6, wherein the first GDD STA selects a first specific channel of the plurality of specific channels and sends the TVWS action frame on the first specific channel in a first beacon interval.

8. The method of claim 7, wherein when P2P communication is not begun within the first beacon interval, the first GDD STA will select a next specific channel of the plurality of specific channels, send a probe request on the next specific channel, and send the TVWS action frame on the first specific channel in a next beacon interval.

9. The method of claim 8, further comprising:
successively sending a probe request on each specific channel after sending the TVWS action frame on the first specific channel every beacon interval; and
when the first GDD STA and the second GDD STA are both listening on a same specific channel, the second GDD STA will receive the probe request and send a probe response to the first GDD STA for beginning P2P communication.

10. A communications system for enabling peer to peer (P2P) communication on a television white space (TVWS) frequency band, the communications system comprising:
a geo-location database (GDB) which stores information of available TVWS channels and corresponding power constraints; and
a first geo-location database dependent (GDD) station (STA) which communicates with the GDB to retrieve the information of available TVWS channels and corresponding power constraints, sends a TVWS action frame by the first GDD STA, wherein the TVWS action frame includes this information, and selects a plurality of specific channels from the plurality of available TVWS channels to listen for other GDD STAs including at least a second GDD STA;
wherein when the second GDD STA and the first GDD STA are both listening on a same specific channel, P2P communication is begun between the first GDD STA and the second GDD STA.

11. The communications system of claim 10, wherein the second GDD STA also communicates with a GDB to retrieve information of available TVWS channels and corresponding power constraints from the GDB, selects a plurality of specific channels from the plurality of available TVWS channels to listen for GDD STAs including the first GDD STA, and includes this information in an TVWS action frame sent by the second GDD STA.

12. The communications system of claim 11, wherein when P2P communication begins between the first GDD STA and the second GDD STA, the first GDD STA and the second GDD STA perform Group Owner (GO) negotiation to determine which GDD STA will initiate transmission.

13. The communications system of claim 10, wherein the second GDD STA has no geo-location capability to communicate with the GDB, and when the second GDD STA receives the TVWS action frame, the second GDD STA begins listening for GDD STAs on the plurality of specific channels in the TVWS action frame.

14. The communications system of claim 13, wherein the second GDD STA has a Group Owner (GO) parameter set to zero, so that when P2P communication begins between the first GDD STA and the second GDD STA, the first GDD STA will become the Group Owner (GO) to initiate transmission.

15. The communications system of claim 10, wherein the plurality of specific channels is a first three channels retrieved from the GDB.

16. The communications system of claim 15, wherein the first GDD STA selects a first specific channel of the plurality of specific channels and sends the TVWS action frame on the first specific channel in a first beacon interval.

17. The communications system of claim 16, wherein when P2P communication is not begun within the first beacon interval, the first GDD STA will select a next specific channel of the plurality of specific channels, send a probe request on the next specific channel and send the TVWS action frame on the first specific channel in a next beacon interval.

18. The communications system of claim 17, wherein a probe request is successively sent by the first GDD STA on each specific channel after the TVWS action frame is sent on the first specific channel every beacon interval, and when the first GDD STA and the second GDD STA are both listening on a same specific channel, the second GDD STA will receive the probe request and send a probe response to the first GDD STA for beginning P2P communication.
